(19) United States
(12) Patent Application Publication
(10) Pub. No.: US 2009/0027112 A1
(43) Pub. Date: Jan. 29, 2009

(54) CONTROLLABLE PRECISION TRANSCONDUCTANCE

(76) Inventors: Chin Li, Murray Hill, NJ (US); Donal Bourke, Cork (IE); Joseph G. DeCarlo, West Paterson, NJ (US)

Correspondence Address: Tyco Technology Resources, Suite 140, 4550 New Linden Hill Road, Wilmington, DE, 19808, US

(21) Appl. No.: 11/828,419

(22) Filed: Jul. 26, 2007

(51) Int. Cl. G05F 3/02

(52) U.S. Cl. 327/540

(57) ABSTRACT

Techniques for providing precise transconductance values are disclosed. For instance, an apparatus includes a slave transconductance cell and a control loop. The control loop provides a tuning voltage to the slave transconductance cell. Moreover, the control loop includes a master transconductance cell that generates a master output current, and a current amplifier that generates the tuning voltage based on an error signal. The error signal reflects a difference between a reference current and the master output current. Further, the current amplifier provides the tuning voltage to the master transconductance cell.

### BACKGROUND

Devices that transmit wireless signals, such as mobile telephones, often include a power amplifier that amplifies signals to a level suitable for wireless transmission. Such devices often require precise currents based on input voltages. For example, mobile telephones may include power amplifiers that are driven by driver circuits. These driver circuits provide the power amplifiers with driver currents that provide various features. For instance, the driver currents may provide the power amplifiers with functions, such as baseband signal processing, biasing, power control, and power optimization. Accordingly, precise driver currents are often desirable.

Driver currents may originate from currents generated by transconductance cells based on input voltages. Unfortunately, environmental factors may cause transconductance cells to provide imprecise or varying transconductance values. Examples of such environmental factors include variations in temperature and process.

Thus, techniques for providing accurate and controllable transconductance values may be desired.

### SUMMARY

The present invention provides various embodiments that may provide for precise transconductance values. For instance, an apparatus includes a slave transconductance cell and a control loop. The control loop provides a tuning voltage to the slave transconductance cell. Moreover, the control loop includes a master transconductance cell that generates a master output current, and a current amplifier that generates the tuning voltage based on an error signal. The error signal reflects a difference between a reference current and the master output current. Further, the current amplifier provides the tuning voltage to the master transconductance cell.

A further apparatus includes a master transconductance cell, a current digital to analog converter (DAC), and a current amplifier. The master transconductance cell generates a master output current from one or more biasing voltages in accordance with a tuning voltage. The current DAC produces a reference current based on an input control word. The current amplifier generates the tuning voltage based on an error signal that reflects a difference between the reference current and the master output current.

Moreover, a method includes generating a master output current from one or more input biasing voltages in accordance with a transconductance value that is determined by a tuning voltage. Based on an error signal that reflects a difference between a reference current and the master output current, the method generates the tuning voltage. In addition, the method provides the tuning voltage to a slave transconductance cell.

### BRIEF DESCRIPTION OF THE DRAWINGS

FIG. 1 is a diagram of an exemplary apparatus;

FIG. 2 is a schematic of an exemplary current amplifier implementation;

FIG. 3 is a schematic of an exemplary transconductance cell implementation;

FIG. 4 is a graph showing various driver currents;

FIG. 5 is a diagram of multiple power amplifier stages;

FIG. 6 is a graph showing variations in driver currents; and

FIG. 7 is a graph showing transient response characteristics.

### DETAILED DESCRIPTION

Various embodiments may generally involve transconductance circuits. For instance, embodiments may include a master transconductance which is controlled by a current amplifier and a reference current. In particular, the master transconductance is controlled by a tuning voltage that is generated by the current amplifier. This tuning voltage is also provided to a slave transconductance. The slave transconductance may provide an input current to a driver circuit. Based on the input current, the driver circuit may provide a driver current to a power amplifier. Thus, embodiments may advantageously provide precise and stable transconductance values that are also user selectable.

Although embodiments may be described with a certain number of elements in a particular arrangement by way of example, the embodiments are not limited to such examples. For instance, embodiments may include greater or fewer elements, as well as other arrangements among elements.

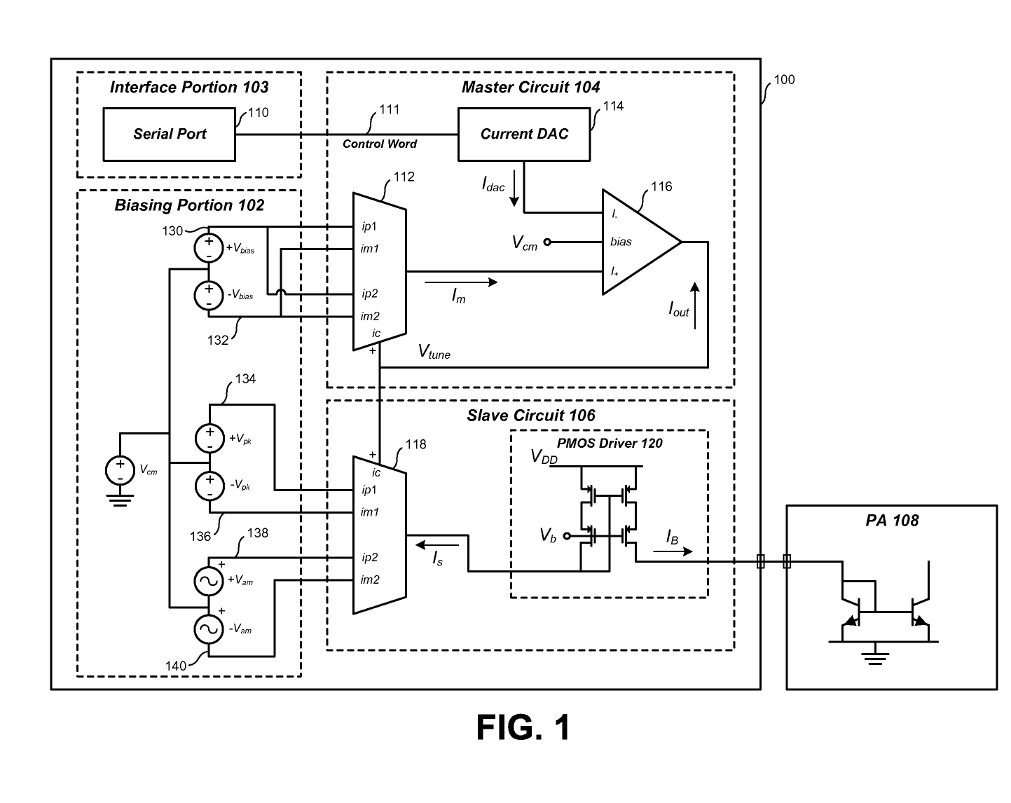

FIG. 1 is a diagram of an apparatus 100 that may provide a substantially constant (yet adjustable) transconductance. Apparatus 100 may include various elements. For instance, FIG. 1 shows apparatus 100 including a biasing portion 102, an interface portion 103, a master circuit 104, and a slave circuit 106. Further, FIG. 1 shows that apparatus 100 is coupled to a power amplifier (PA) 108.

Biasing portion 102 provides master circuit 104 and slave circuit 106 with various voltages. For instance, biasing portion 102 provides master circuit 104 with bias voltages 130 and 132. As shown in FIG. 1, voltages 130 and 132 are offset from a common mode voltage Vₑₘ by voltages +V_{bias} and −V_{bias}, respectively. These voltages may be highly precise. For instance, in embodiments, +V_{bias} and −V_{bias} are derived from a precise source, such as a semiconductor (e.g., silicon semiconductor) band gap voltage. Similarly, Vₑₘ may also be derived from such a precise source. Accordingly, in embodiments, these voltages may be obtained through band-gap reference biasing circuits. Such circuits may provide precise voltages (e.g., within approximately ±2.5% or lower).

Further, biasing portion 102 provides slave circuit 106 with peak voltages 134 and 136. As shown in FIG. 1, these voltages are offset from Vₑₘ by Vₚₖ and −Vₚₖ, respectively. Also biasing portion 102 provides slave circuit 106 with amplitude signals 138 and 140, which are offset from Vₑₘ by Vₐₘ and −Vₐₘ, respectively.

+Vₐₘ and −Vₐₘ are time varying voltage signals. Further, −Vₐₘ is the negative Of +Vₐₘ. (i.e., they are 180 degrees out of phase). In embodiments, these signals may be baseband signals that convey an information sequence. For example, +Vₐₘ and −Vₐₘ may be amplitude modulated (AM) signals. The embodiments, however, are not limited to this modulation scheme. Thus, +Vₐₘ and −Vₐₘ may be in accordance with various formats and/or modulation schemes. +Vₚₖ and −Vₚₖ (which are equal in magnitude, but opposite in sign) are the peak values of +Vₐₘ and −Vₐₘ.

Interface portion 103 includes a serial port 110, which provides a control word 111 to a current digital to analog converter (DAC) 114 within master circuit 104. Various types of serial ports may be employed. Examples include Universal Serial Bus (USB) and Electronic Industries Alliance (EIA) RS-232 interfaces. The embodiments, however, are not limited to these examples. Moreover, interfaces other than serial ports may be employed.

FIG. 1 shows that master circuit 104 includes a master transconductance cell (Gm cell) 112, current DAC 114, and a current amplifier 116. Master Gm cell 112 has five input terminals (ip1, im1, ip2, im2, and ic). As shown in FIG. 1, terminals ip1 and ip2 receive bias voltage 130, while terminals im1 and im2 receive bias voltage 132. Further, control input terminal ic receives a voltage Vₜᵤₙₑ from current amplifier 116. Based on these inputs, master Gm cell 112 produces a master output current Iₘ.

Current DAC 114 generates a reference current I_{dac} that is sent to current amplifier 116. This reference current is based on control word 111, which is received from serial port 110 of interface portion 102.

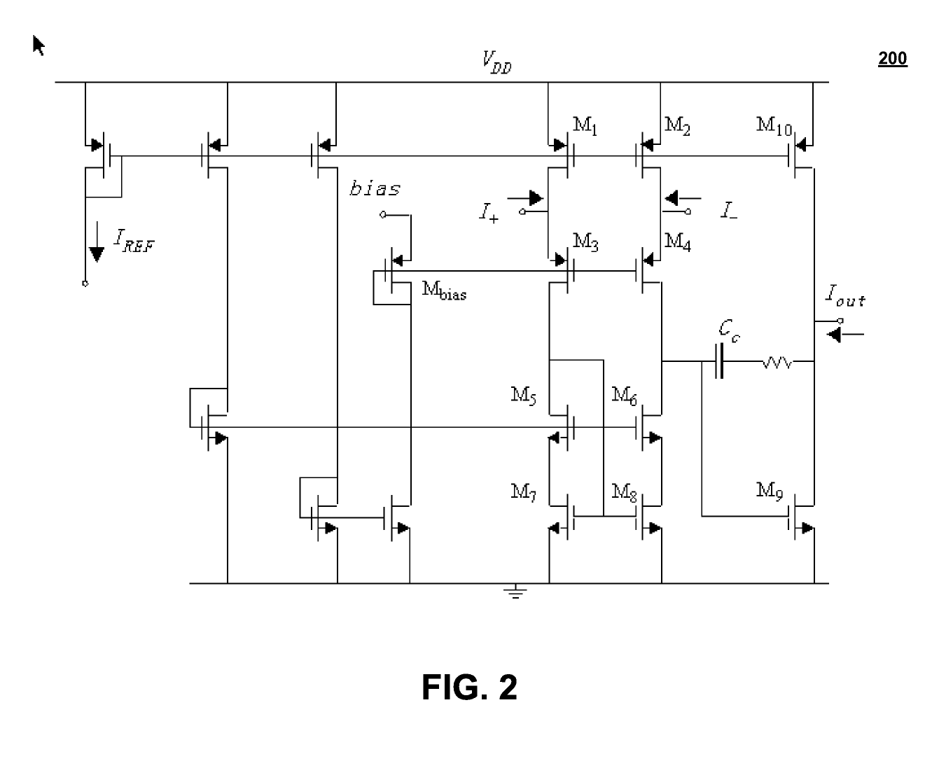

Current amplifier 116 includes three input terminals: differential input terminals I₊ and I₋, and a bias input terminal. As shown in FIG. 1, input terminal I₋ receives current I_{dac} from current DAC 114, input terminal I₊ receives master output current Iₘ from master Gm cell 112, and the bias input terminal receives common mode voltage V_{cm}. Based on these inputs, current amplifier 116 generates an output current Iₒᵤₜ, which exists at a voltage Vₜᵤₙₑ. As shown in FIG. 1, Vₜᵤₙₑ is provided to both master Gm cell 112 within master circuit 104 and a slave Gm cell 114 that is within slave circuit 106. Details regarding an exemplary implementation of current amplifier 116 are provided below with reference to FIG. 2.

FIG. 1 shows that slave circuit 106 includes a slave transconductance cell (Gm cell) 118, and a driver circuit 120. Slave Gm cell 118 (like master Gm cell 112) includes five input terminals (ip1, im1, ip2, im2, and ic). FIG. 1 shows terminal ip1 receiving voltage 134, terminal im1 receiving voltage 136, terminal ip2 receiving voltage 138, and terminal im2 receiving voltage 140. Also, FIG. 1 shows input control terminal, ic, receiving voltage Vₜᵤₙₑ from current amplifier 116. Based on these inputs, slave Gm cell 112 produces a slave output current Iₛ. As shown in FIG. 1, this output current is provided to driver circuit 120.

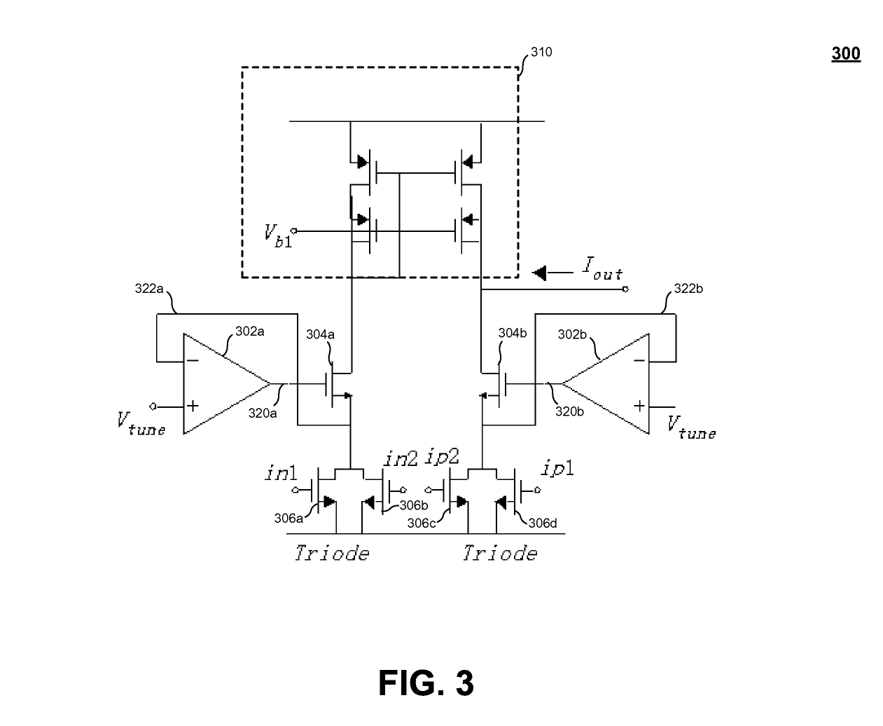

In embodiments, master Gm cell 112 and slave Gm cell 118 have the same implementations. Thus, they may be substantially identical. However, as described, herein, each of these components are operated differently. Details regarding an exemplary implementation of Gm cells 112 and 118 are provided below with reference to FIG. 3.

In general operation, apparatus 100 provides for the transconductance values (Gm) of Gm cells 112 and 118 to be accurately controlled. This control is based on a control loop within master circuit 104.

More particularly, master circuit 104 provides a control loop including master Gm cell 112 and current amplifier 116. Through this control loop, master Gm cell 112 receives negative feedback from current amplifier 116. For instance, based on fixed input voltages 130 and 132, master Gm cell produces output current Iₘ. At current amplifier 116, master output current Iₘ is compared with reference current I_{dac} from current DAC 114. This comparison represents an error signal, which current amplifier 116 amplifies to produce tuning voltage, Vₜᵤₙₑ. This tuning voltage is applied to master Gm cell 112 (at its control terminal ic) in such a way so that the error signal (at current amplifier 116) is minimized.

As described above, tuning voltage Vₜᵤₙₑ is applied to the control terminals (ic) of both master Gm cell 112 and slave Gm cell 118. Thus, slave Gm cell 118 may have a transconductance that is substantially the same as the transconductance of master Gm cell 112.

Within slave circuit 106, slave Gm cell 118 is operated in an open loop configuration. Thus, slave Gm cell 118 is arranged to convert a difference between voltages +Vₐₘ and −Vₐₘ into slave output current Iₛ. Moreover, as described above, slave Gm cell 118 receives biasing voltages +Vₚₖ and −Vₚₖ, which vary with the power of +Vₐₘ and −Vₐₘ. This may ensure that Iₛ is substantially zero when +Vₐₘ and −Vₐₘ are at their minimum.

As described above, the input voltages applied at master Gm cell 112 may be highly precise. Also, I_{dac} from current DAC 114 may be highly precise. Moreover, in embodiments, Gm cells 112 and 118 are implemented on the same die and have matched (or substantially identical) properties. Thus, the transconductance value (Gm) obtained at Gm cells 112 and 118 may be controlled with a high degree of precision. Also, for at least these reasons, this Gm value may be substantially independent from process and temperature variations. However, variations in process and temperature may necessitate changes in the tuning voltage Vₜᵤₙₑ to maintain a constant Gm. Such variations are automatically carried out through the control loop arrangement of master circuit 104.

FIG. 1 shows that driver circuit 120 is coupled to slave Gm cell 118. In particular, driver circuit 120 receives Iₘ from slave Gm cell 118. From this, driver circuit 120 produces a driving current I_{B}, which is sent to power amplifier 108. This current may reflect the information conveyed in signals +Vₐₘ and −Vₐₘ. Driver circuit 120 may be implemented in various ways. For example, FIG. 1 shows driver circuit 120 implemented as a PMOS circuit. The embodiments, however, are not limited to such.

In addition to being precise, apparatus 100 is also programmable. For instance, by setting control word 111, a user may select a desired transconductance value for Gm cells 112 and 118. As described above, Vₜᵤₙₑ (which controls Gm) is based on an error signal reflecting a difference between Iₘ and I_{dac}. Since I_{dac} is determined by control word 111, then control word 111 determines Gm. This programmability may advantageously provide power efficiency and/or optimization to the power amplifier (e.g., PA 108) which apparatus 100 is driving.

Apparatus 100 may be implemented according to various techniques. In embodiments, apparatus 100 is fabricated on a single chip or die. For example, apparatus 100 may be fabricated using a 0.18 um/0.4 um 1.8V/3.3V, single-poly, 7-metal BiCMOS process. The embodiments, however, are not limited to this example.

As described above, driver circuit 120 provides driver current I_{B} to PA 108. PA 108 may amplify this current for wireless transmission. Additionally or alternatively, multiple PAs (or multiple PA stages) may be employed which perform functions, such as polar modulation, based on driver current IB. Such power amplifiers may employ (but are not limited to) hetereobipolar junction transistors (HBTs). Accordingly, apparatus 100 (as well as such power amplifiers) may be included in devices, such as wireless telephones.

FIG. 2 is a schematic showing an implementation 200 of current amplifier 116. This implementation is provided for purposes of illustration and not limitation. Therefore, embodiments may employ other current amplifier implementations. As shown in FIG. 2, implementation 200 includes multiple field effect transistors (FETs). These FETs include M_{bias}, M₁, M₂, M₃, M₄, M₅, M₆, M₇, M₈, M₉, and M₁₀. Further, implementation 200 includes a compensation capacitor Cc.

The current amplifier implementation of FIG. 2 amplifies the difference between currents received at input terminals I₊ and I₋, thus producing output current Iₒᵤₜ. As described above with reference to FIG. 1, input terminal I₊ may receive current Iₘ from master gm cell 112 and input terminal I₋ may receive current I_{dac} from current DAC 114. The DC input to output current transfer function for implementation 200 is expressed below in Equation (1).

$${I}_{out} = ( {I}_{+} - {I}_{-} ) \cdot ( \frac{( \frac{{g}_{m 4}}{{g}_{ds 4}} )}{{g}_{ds 2} + {g}_{dac}} + \frac{( \frac{{g}_{m 6}}{{g}_{ds 6}} )}{{g}_{ds 8}} ) {g}_{m 9} \qquad ( 1 )$$

In Equation (1), g_{dac} is the output conductance of current DAC 114, gₘ₄ is the transconductance of M₄, gₘ₆ is the transconductance of M₆, gₘ₉ is the transconductance of M₉, g_{ds2} is the output conductance of M₂, g_{ds4} is the output conductance of M₄, g_{ds6} is the output conductance of M₆, and g_{ds8} is the output conductance of M₈.

Current amplifier 200 provides relatively low input impedance. Therefore, when implemented in apparatus 100 of FIG. 1, it can affect the operations of master gm cell 112 and current DAC 114. Thus, the input operating point of current amplifier 200 is set to V_{cm} via M_{bias}. V_{cm} is the common mode voltage level of the differential input signal received at terminals I₊ and I₋ (e.g., Iₘ−I_{dac}). In embodiments, Vₑₘ is set to 2.0 Volts.

As described above, the current amplifier implementation of FIG. 2 may be employed in a control loop within master circuit 104 of FIG. 1. Stability of this control loop may be achieved through a dominant pole that is based on compensation capacitor Cc.

FIG. 3 is a schematic showing an exemplary transconductance cell implementation 300. With reference to FIG. 1, this implementation may be used for both master Gm cell 112 and slave Gm cell 118.

As shown in FIG. 3, implementation 300 includes operational amplifiers (op-amps) 302a and 302b. Each of these op-amps may employ a folded cascade topology with p-channel differential pairs to allow low input signal range. The embodiments, however, are not limited to such.

FIG. 3 shows that op-amp 302a provides a control signal 320a to the gate terminal of a FET 304a. Likewise, op-amp 302b provides a control signal 320b to the gate terminal of a FET 304b. These signals are based on inputs received at the non-inverting and inverting input terminals of op-amps 302a and 302b.

For instance, FIG. 3 shows that op-amp 302a receives Vₜᵤₙₑ at its non-inverting input terminal and a feedback signal 322a at its inverting input terminal. Likewise, op-amp 302b receives Vₜᵤₙₑ at its non-inverting input terminal and a feedback signal 322b at its inverting input terminal. As shown in FIG. 3, feedback signals 322a and 322b are received from the source terminals of FETs 304a and 304b, respectively.

Implementation 300 includes four input devices 306a-d. These are shown in FETs. However, the embodiments are not limited to such devices. As shown in FIG. 3, input devices 306a-d are biased to operate in the triode region.

The gate terminals of devices 306a-d may implement the input terminals of gm cells 112 and 118 in FIG. 1. For instance, FIG. 3 shows that the gate terminal of device 306a implements input terminal in1, the gate terminal of device 306b implements input terminal in2, the gate terminal of device 306c implements input terminal ip2, and the gate terminal of device 306d implements input terminal ip1. Also, the non-inverting input terminals of op-amps 302a and 302b (which receive Vₜᵤₙₑ) may provide input control terminal ic.

Further, implementation 300 includes a current mirror circuit 310. As shown in FIG. 3, current mirror circuit receives a bias voltage V_{b1}. As V_{b1} is not shown in FIG. 1, it is referred to herein as an internal bias voltage. This bias voltage may be set in accordance with the operational environment of implementation 300. Current mirror circuit 310 provides for single-ended output Iₒᵤₜ to be generated from the differential inputs described herein.

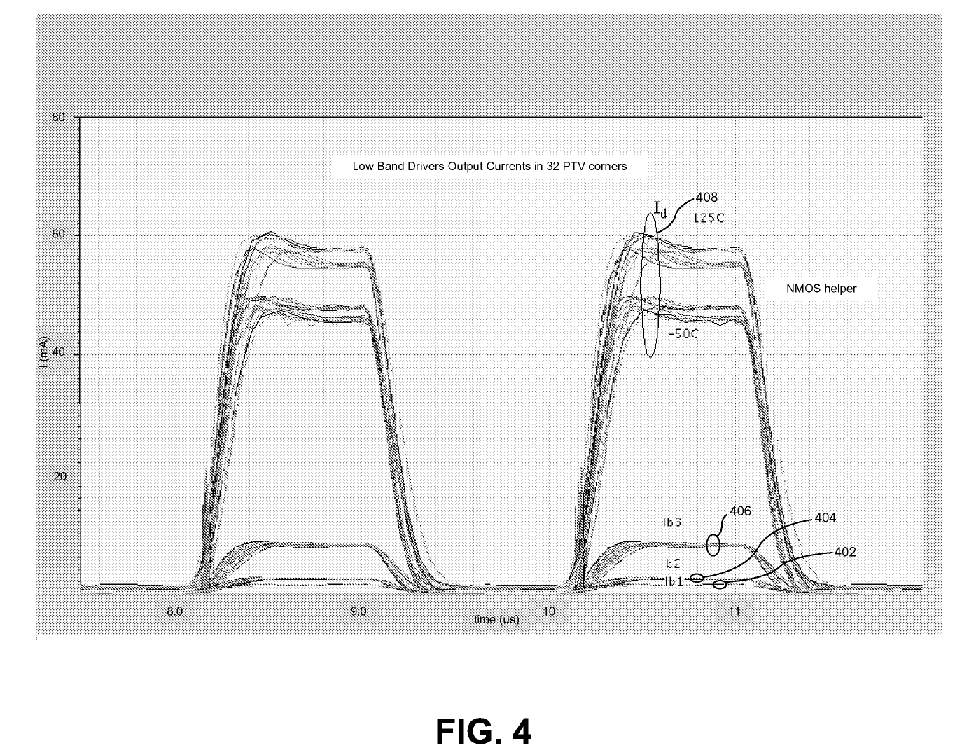

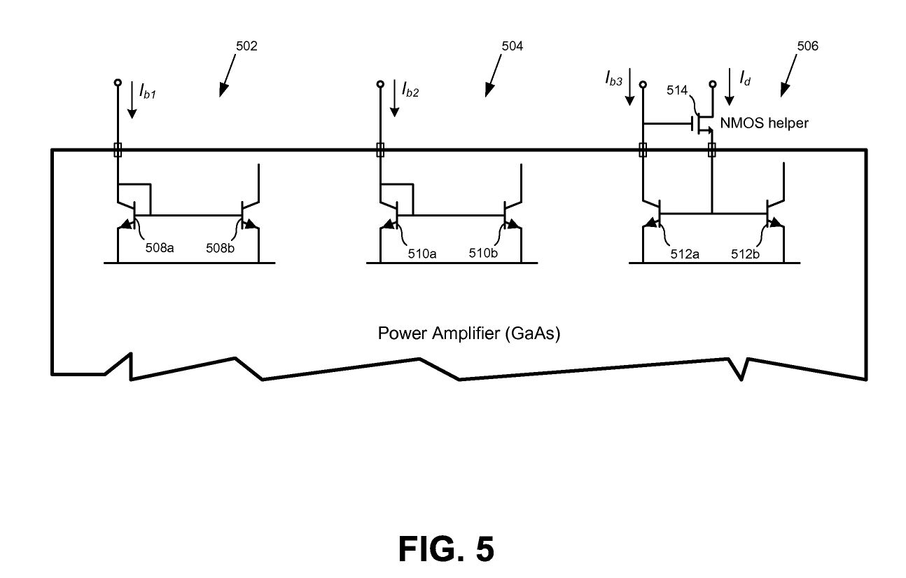

FIG. 4 illustrates driver currents generated through simulation. In particular FIG. 4 is a graph showing driver currents I_{b1}, I_{b2}, I_{b3}, and I_{d}, generated by the architecture of FIG. 1 (e.g., an implementation of apparatus 100 for each driver circuit) to a three stage power amplifier shown in FIG. 5. Thus, these driver currents are derived from slave Gm cells, as described herein.

FIG. 5 is a diagram of a three stage power amplifier having a first stage 502, a second stage 504, and a third stage 506. For purposes of clarity, interconnections between these stages are not shown. As shown in FIG. 5, driver current I_{b1} is provided to first stage 502, and driver current I_{b2} is provided to second stage 504. Further, FIG. 5 shows driver currents I_{b3} and I_{d} being provided to third PA stage 506. These stages include heterojunction bipolar transistors (HBTs). For instance, FIG. 5 shows that first PA stage 502 includes HBTs 508a-b, second PA stage 504 includes HBTs 510a-b, and third PA stage 506 includes HBTs 512a-b. Further, FIG. 5 shows PA 506 including an NMOS FET (NMOS helper) 514. PA stages 502, 504, and 506 are implemented with a Gallium Arsenide (GaAs) process.

FIG. 4 shows driver current variations (i.e., variations in I_{b1}, I_{b2}, I_{b3}, and I_{d}) resulting from process and temperature variations. More particularly, these results were generated through 32 corner simulations that involved varying NFETs, PFETs, resistors, and capacitors by 3 sigma, and varying the temperature between −50 to 125 degrees Celsius.

As a result, the graph of FIG. 4 includes a grouping 402 showing variations in i_{b1}, a grouping 404 showing variations in i_{b2}, a grouping 406 showing variations in i_{b3}, and a grouping 408 showing variations in i_{d}. These groupings indicate that the variations of these driver currents are within ±8%. (The separation in I_{d} grouping 408 is due to beta variations of the GaAs process.) Thus, the corresponding slave Gm cell output currents are also stabilized to within ±8%. This is highly stable in light of the amount Vₜᵤₙₑ has to be adjusted to provide these results.

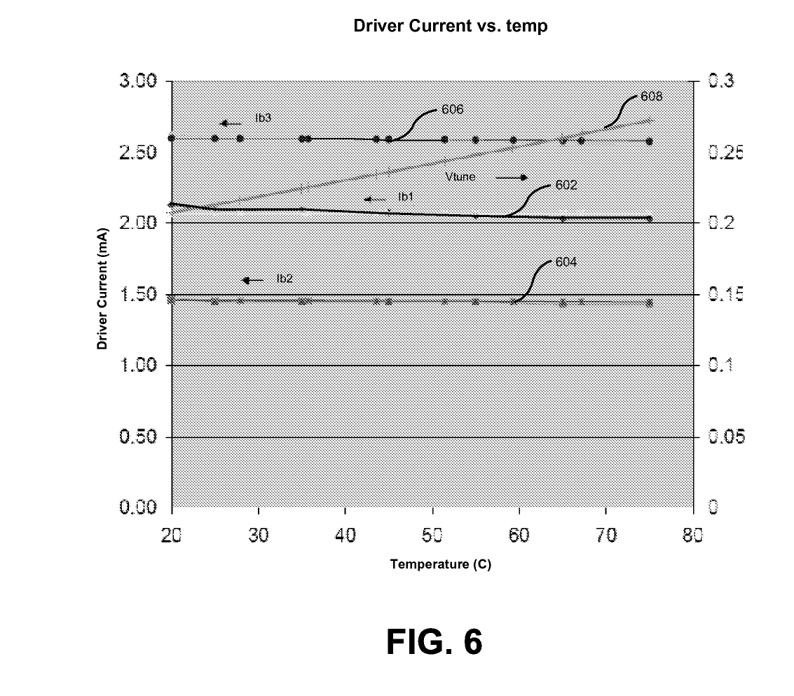

FIG. 6 is a graph showing variations in the driver currents of FIG. 5 across a range of temperatures from 20 degrees Celsius to 75 degrees Celsius. In particular, the graph of FIG. 6 includes a curve 602 showing variations in driver current i_{b1}, a curve 604 indicating variations in driver current i_{b2}, and a curve 606 indicating variations in driver current i_{b3}. In addition, the graph of FIG. 6 includes a curve 608 indicating variations in Vₜᵤₙₑ across this temperature range. These curves are based on results obtained through simulation and through actual measurements.

Curves 602, 604, and 606 show the corresponding driver currents being substantially constant (i.e., within approximately ±2.5%). In contrast, curve 608 shows that Vₜᵤₙₑ increases significantly (by approximately 31%) across the temperature range. With reference to the architecture of FIG. 1, these changes in Vₜᵤₙₑ are caused by the master circuit control loop.

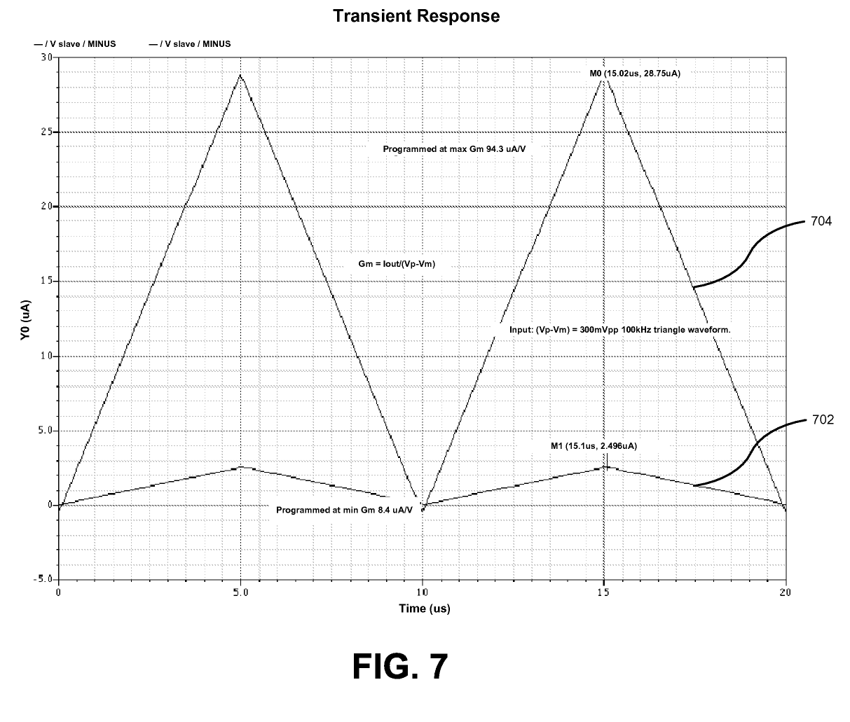

FIG. 7 is a graph showing transient response characteristics. In particular, the graph of FIG. 7 shows triangle waveforms 702 and 704, which are output currents provided by slave Gm cell 118. More particularly, triangle waveform 702 is produced when slave Gm cell 118 is programmed to have a transconductance of 8.4 micro Siemens (uS), while triangle waveform 704 is produced when slave Gm cell 118 is programmed to have a transconductance of 94.3 uS.

Through simulation, each of waveforms 702 and 704 are produced from constant input triangle signals to the slave Gm cell, while tuning voltage Vₜᵤₙₑ has been adjusted from minimum to maximum. Based on this a Gm ratio of 11.2:1 is exhibited. However, for embodiments in which current DAC 114 is implemented on a chip produces, a reduced range may chosen for implementation reasons. For instance, such a reduced range may provide transconductances between 15.8 uS to 48 uS.

Thus, as shown in FIGS. 4, 6, and 7, precise and stable transconductance values may be achieved across ranges of operating conditions. Such operating conditions may involve temperature and/or process variations. For example, embodiments may maintain transconductance values within ±2.5% over a range of temperatures from 20 to 75 degrees Celsius.

Embodiments may be implemented according to various techniques, and may possess a variety of characteristics. Exemplary implementation characteristics are provided below in Table 1.

TABLE 1

| Implementation Parameter | Value |
|---|---|
| Area of master gm control loop with | 90,000 um² |
| current dac | |
| Process | 0.18/0.4 um, BiCMOS, 7M |
| Supply Voltage | 1.8 V/3.3 V |
| Current of master Gm control loop | 960 uA |
| with DAC | |
| Gm programmability range | 11.2:1 |
| Gm programmability range on chip | 3:1 |
| Gm variation due to temperature, 20-75 | <±2.5% |
| degrees C. | |
| Minimum Gm | 8.4 uS |
| Maximum Gm | 94.3 uS |
| Minimum Gm implemented on chip | 15.8 uS |
| Maximum Gm implemented on chip | 48.0 uS |

The implementation characteristics provided in Table 1 are for purposes of illustration, and not limitation. Thus, embodiments may be implemented according to (or exhibit) different characteristics.

While various embodiments of the present invention have been described above, it should be understood that they have been presented by way of example only, and not in limitation. For instance, FIGS. 2 and 3 show implementations involving FETs. However, embodiments may employ other device types, such as bipolar junction transitors (BJTs), heterojunction bipolar transistor (HBTs), and so forth. Also, FIG. 5 shows power amplifier stages implemented HBTs. However, other device types may be employed. Thus, the embodiments are not limited to particular device types or processes.

Accordingly, it will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

1. An apparatus, comprising:
a slave transconductance cell; and
a control loop to provide a tuning voltage to the slave transconductance cell, the control loop including a master transconductance cell to generate a master output current, and a current amplifier to generate the tuning voltage based on an error signal;
wherein the error signal reflects a difference between a reference current and the master output current; and
wherein the current amplifier is to further provide the tuning voltage to the master transconductance cell.

2. The apparatus of claim 1, wherein the master transconductance cell and the slave transconductance cell are implemented on a single integrated circuit die.

3. The apparatus of claim 1, further comprising:
a digital to analog converter to generate the reference current from a control word.

4. The apparatus of claim 3, wherein the control word is user selectable.

5. The apparatus of claim 1, wherein the master transconductance device is to receive one or more input biasing voltages, the input biasing voltages based on a semiconductor band gap voltage.

6. The apparatus of claim 1, wherein the slave transconductance cell generates a slave output current from one or more baseband input signals.

7. The apparatus of claim 6, further comprising a driver circuit to produce a driver current from the slave output current.

8. The apparatus of claim 7, further comprising a power amplifier to receive the driver current.

9. The apparatus of claim 8, wherein the power amplifier amplifies the driver current for wireless transmission.

10. The apparatus of claim 1, wherein the tuning voltage establishes a transconductance value for the master transconductance cell and the slave transconductance cell.

11. An apparatus, comprising:
a master transconductance cell to generate a master output current from one or more biasing voltages in accordance with a tuning voltage;
a current digital to analog converter (DAC) to produce a reference current based on an input control word; and
a current amplifier to generate the tuning voltage based on an error signal reflecting a difference between the reference current and the master output current.

12. The apparatus of claim 11, wherein the tuning voltage establishes a transconductance value for the master transconductance cell.

13. The apparatus of claim 11, further comprising a slave transconductance cell, the slave transconductance cell to produce an output current from one or more baseband signals, wherein the slave transconductance cell is to receive the tuning voltage.

14. The apparatus of claim 13, wherein the tuning voltage establishes a transconductance value for the master transconductance cell and the slave transconductance cell.

15. The apparatus of claim 13, wherein the master transconductance cell and the slave transconductance cell are implemented on a single integrated circuit die.

16. The apparatus of claim 13, further comprising a driver circuit to produce a driver current from the slave output current.

17. The apparatus of claim 16, further comprising a power amplifier to receive the driver current.

18. The apparatus of claim 17, wherein the power amplifier amplifies the driver current for wireless transmission.

19. A method, comprising:
generating a master output current from one or more input biasing voltages in accordance with a transconductance value, the transconductance value determined by a tuning voltage
generating the tuning voltage based on an error signal, the error signal reflecting a difference between a reference current and the master output current; and
providing the tuning voltage to a slave transconductance cell.

20. The method of claim 19, further comprising receiving the reference current from a current digital to analog converter (DAC).
